(19) United States
(12) Patent Application Publication
(10) Pub. No.: US 2004/0015395 A1
(43) Pub. Date: Jan. 22, 2004

(54) Method and system of generating an incentive at a point of sale

(76) Inventor: Charles Acosta, Clearwater Beach, FL (US)

Correspondence Address: BAKER & BOTTS, 30 ROCKEFELLER PLAZA, NEW YORK, NY, 10112

(21) Appl. No.: 10/201,422

(22) Filed: Jul. 21, 2002

(51) Int. Cl. G06F 17/60

(52) U.S. Cl. 705/14

(57) ABSTRACT

A system and method of receiving an inquiry in response to an offer extended to a customer at a point of sale is provided. The method of receiving an inquiry in response to an offer extended to a customer at a point of sale includes receiving information about a customer including a customer entry number and information indicative of the customer's purchasing history, the information being obtained at least in part as part of an earlier point of sale transaction with the customer. The method further includes receiving an inquiry from an inquirer via telecommunication contact information provided to the customer at the point of sale, the inquiry including receiving from the inquirer the customer entry number, and providing the inquirer the benefit offered to the customer at the point of sale. The method also includes offering at least one of a product and service to the inquirer based at least in part on the customer's purchasing history.

### FIELD OF THE INVENTION

This application relates to methods and systems for communicating marketing information to a customer. More particularly, this invention relates to communicating marketing information to a customer by enticing a customer to call an inbound call center in response to an offer extended to the customer at a point of sale.

### BACKGROUND

The point of sale (POS) environment is a highly transactional arena that touches the life of most people on a daily basis. The POS environment is also a highly efficient platform that aggregates the demand of active shoppers into individualized data collection channels. Analyzing these individualized data collection channels affords marketers the opportunity to communicate with active customers and utilize their transaction information to better target offers to them. An important benefit of the information collected at the POS is that it is uniquely individualized to the customer at the POS and that the data represents the customer's most recent transactional behavior.

In the past, marketers have attempted to extend the POS transaction window, but they have been limited to aftermarket channels, such as direct mailing or telemarketing, in order to contact the customer once the customer has left the POS with promotional material, e.g., discount coupons. If a marketer sends out discount coupons to a customer, the customer receives the discount coupons long after they have made their purchase and therefore exited the consumption mode. In other words, the discount coupons are reaching the customer at a time when the customer may not wish to purchase an associated product or when the customer is not willing or able to make a purchasing decision. Other attempts at reaching the customer have included generating a discount coupon at the POS. Generally, the discount coupon produced at the POS simply offers a discounted price on a product that is related to or competitive with the product purchased at the POS. For example, Company X may provide for a coupon to be printed at the POS that includes an offer to receive a certain amount off of a contact lens purchase if a related product was purchased. One of the chief problems with this marketing approach is that this solution only targets a highly motivated customer, for example, a customer that has already made the decision to purchase a product associated with contact lenses, thereby severely limiting the potential volume of transactions that occur at the POS terminal. Consequently, the discount coupon will actually target a product's best and most loyal customers with a vehicle that actually reduces the product's profitability, due to the money spent on the promotion and the promotion itself.

In order to have the best chance at completing a sale, the “promotion” of an offer should be extended to a customer in a highly flexible environment and the offer should target a wide range of potential customers including those that are loyal as well as the customers who are uncommitted. For example, direct mail pieces, unlike small single color point of sale coupons, allow for a large number of colors, photos and offers to take place in one piece of direct mail. Further, telemarketing campaigns allow for a large amount of flexibility, as live sales representatives can shape an offer based on specific customer needs. Use of telemarketing campaigns and direct mail pieces has increased, however the direct marketing industry has been facing a continued decline in response to its solicitations. Contributing factors to this decline include an over-proliferation of companies using direct mail to target customers, and an overall desensitization of customers leading them to recognize direct marketing efforts quickly and lose any interest. Customers have grown savvier to direct marketing efforts and it has become increasingly hard for marketers to gain attention or increase direct mail open rates. Compounding this issue is the subsequent increase in direct marketing costs. The two biggest cost drivers, paper and postage, continue to outpace normal inflationary increases. The result is that direct marketers are facing minimum costs of $0.05-$0.06 per piece, costs that are making it increasingly difficult for marketers to achieve acceptable margins. The convergence of these two factors is forcing marketers to “get out of the mail” and look for new and alternate channels to deliver their message. These new and alternate channels include the internet, television, print, and radio, but these alternate channels have not necessarily decreased the acquisition cost of a customer.

### SUMMARY OF THE INVENTION

Thus, it is an object of the invention to provide a system and method that will generate an incentive at the POS that will motivate customers to enter into an inbound sales platform once they have left the POS.

It is a further object of the invention to provide an encouragement to the customer to call a toll free number with a promise of reward at the end of a call. Therefore, a customer will call soon after leaving the POS, thus capitalizing on the transaction window that was originally created at the POS.

An additional object of the invention is to provide a prize or reward for the customer if the customer calls the toll-free number associated with the incentive. Preferably, the incentive casts a wide net targeting the maximum possible number of customers.

Further objects of the invention are to reduce the costs associated with direct marketing efforts and increase the effectiveness of direct marketing efforts.

Accordingly, a method of receiving an inquiry in response to an offer extended to a customer at a point of sale is provided. The method includes receiving an inquiry in response to a document provided at a point of sale, the document having information including an offer for a benefit and telecommunication contact information for accepting the offer of the benefit, the inquiry being placed by an inquirer using the telecommunication contact information, and offering at least one of an associated product and an associated service to the inquirer.

Further, a method of generating at a point of sale a subsequent offer to an inquirer is provided. The method includes providing a document to a customer at a point of sale, the document having information including an offer for a benefit and telecommunication contact information for accepting the offer of the benefit, and receiving an inquiry via the telecommunication contact information from an inquirer, and offering at least one of an associated product, and an associated service to the inquirer.

Still further, a method of receiving an inquiry in response to an offer extended to a customer at a point of sale is provided. The method of receiving an inquiry in response to an offer extended to a customer at a point of sale includes receiving information about a customer including a customer entry number and information indicative of the customer's purchasing history, the information being obtained at least in part as part of an earlier point of sale transaction with the customer. The method further includes receiving an inquiry from an inquirer via telecommunication contact information provided to the customer at the point of sale, the inquiry including receiving from the inquirer the customer entry number, and providing the inquirer the benefit offered to the customer at the point of sale. And the method still further includes offering at least one of a product and service to the inquirer based at least in part on the customer's purchasing history.

And yet further, a system for receiving an inquiry in response to an offer extended to a customer at a point of sale is provided. The system including an inquiry processing assembly configured to receive inquiries in response to a document provided at a point of sale, the document having information including an offer for a benefit and telecommunication contact information for accepting the offer of the benefit, the inquiry being placed by an inquirer using the telecommunication contact information, and configured to offer at least one of an associated product and an associated service to the inquirer.

### BRIEF DESCRIPTION OF THE DRAWINGS

A more complete understanding of the present invention may be obtained from consideration of the following descriptions, in conjunction with the drawings, of which:

FIG. 1 is a representation of a system for providing an incentive to a customer at the POS according to a preferred embodiment of the present invention;

FIG. 2 is a flow chart showing several processing steps of the method for generating at a point of sale a subsequent offer to a customer according to a preferred embodiment of the present invention; and

FIG. 3 is a flow chart showing several processing steps of the method for collecting on the subsequent offer to a customer according to a preferred embodiment of the present invention.

Throughout the figures, the same reference numerals and characters, unless otherwise stated, are used to denote like features, elements, components or portions of the illustrated embodiments.

### DETAILED DESCRIPTION OF THE PREFERRED EMBODIMENTS

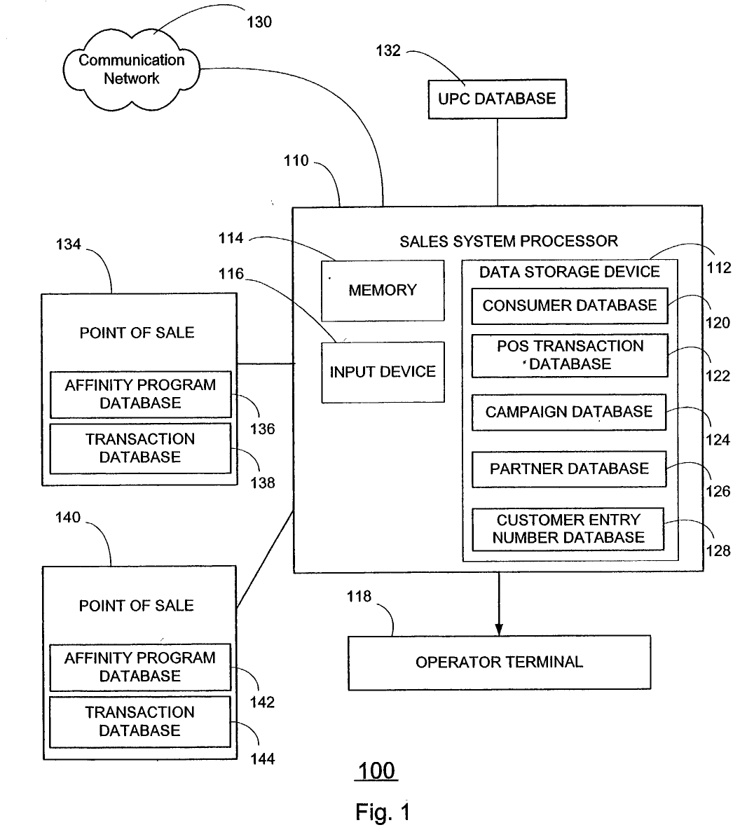

A method and system for generating an offer to a customer at a point of sale (POS) is provided. FIG. 1 shows one embodiment of a system 100 for receiving a call from a customer in response to an offer extended to a customer at a POS in accordance with the invention. The system is provided with a sales system processor 110 for processing computer encoded instructions from a data storage device 112. The sales system processor 110 is essentially an inbound call center and can communicate with a computer memory 114 to facilitate processing of the instructions. In addition, an input device 116 can be provided for a user such as a call center operator to enter information or instruct the sales system processor 110 to take certain actions in accordance with the instructions. The input device 116 can include one or more conventional input devices such as a keyboard or mouse pointing device. In addition, an operator terminal display 118 can be provided to display to a user the instructions, associated data, or a graphical user interface (“GUI”) whereby a user can manipulate the instructions or data among other things.

The data storage device 112 provides instructions embodying portions of a method for generating an offer to a customer at a POS in accordance with the invention and for collecting on the offer. The data storage device 112 can be conventional computable readable storage such as removable magnetic media such as a disk but can also include optical media such as compact disks, fixed magnetic media such as a disk, or electrical media such as RAM. The data storage device 112 is provided with interface instructions for displaying to the user an interface for viewing a script of questions, for entering responses of a caller and for accepting instructions to process or communicate data, among other things. The specific instructions can be provided by one skilled in the art following the further detailed description of the method provided herein. A customer database 120 can be provided for storing and retrieving information related to one or more customers. In addition, a POS transaction database 122 can be provided for storing and retrieving information related to one or more transactions at a POS. In addition, a campaign database 124 can be provided for storing and retrieving information related to one or more campaigns. Each campaign relates to a particular called number. Further, a partner database 126 can be provided for storing and retrieving information related to partner entities and other correspondents, including terms for selling products provided by partner entities. Still further, a customer entry number database 128 can be provided for storing and retrieving records which correlate a customer with an entry number. Although these databases have been described separately, it can be appreciated that the information can be stored and managed within a single, consolidated database and can be integrated with or managed by the interface instructions.

The sales system processor 110 is in communication with a communication network 130 for communicating with a customer. The communication network 130 can be a public switched telephone network for participants to communicate orally, or it can be a computer terminated network, such as the Internet, for communicating information according to layered communication protocol. The communication network 130 can be a wired network, alternatively it can be a wireless network.

The sales system processor 110 can be in communication with a universal product code (UPC) database 132. The UPC database 132 associates a UPC with product information. The product information can include the product name, suggested retail price, and other product characteristics.

The sales system processor 110 can also be in communication with a POS system 134. The POS system 134 includes an affinity program database 136 and a transaction database 138. The affinity program database 136 contains information about certain of the retailer's customers, for example, name, address and telephone number. The information contained in the affinity program database 136 about a particular customer generally corresponds to an affinity program participation number. The transaction database 138 contains information about specific transactions carried out at the POS.

The sales system processor 110 can also be in communication with any number of POS systems. For example, FIG. 1 also illustrates a POS system 140. The POS system 140 includes an affinity program database 142 and a transaction database 144. The affinity program database 142 contains information about certain of the retailer's customers, for example, name, address and telephone number. The information contained in the affinity program database 142 about a particular customer generally corresponds to an affinity program participation number. The transaction database 144 contains information about specific transactions carried out at the POS.

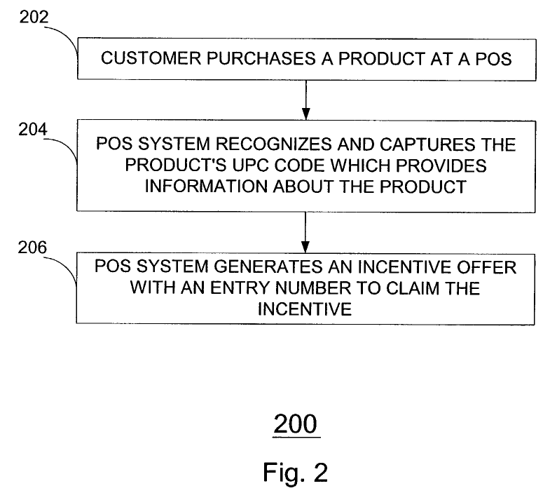

FIG. 2 is a flow chart that illustrates a series of steps 200 wherein the customer receives an incentive from a POS. The series of steps 200 begins at step 202 where a customer selects a product to purchase. The customer may select more than one product to purchase. It should be understood that a product purchased at a POS can be either a product or a service.

At step 204, each product the customer is purchasing is scanned or otherwise entered into the POS system. The POS system captures the UPC for each product while scanning the products. Alternatively, if the product cannot be scanned, the person operating the POS system may key in the UPC associated with the product. The POS system utilizes a UPC database to correlate the UPC with specific attributes of the product. For example, if the product is a magazine, the POS system may retrieve the title of the magazine from the product database.

At step 206, the POS system generates an incentive offer for the customer. The incentive offer may be printed, for example, as a ticket, a sales receipt, a coupon, or a sweepstakes entry. The incentive offer may include an entry number which can be used to claim the incentive. The incentive offer can be anything of value to a potential customer. The incentive offer provides the customer with an incentive for calling the sales system processor 110. The incentive offer may also include telecommunication contact information. The telecommunication contact information may be a telephone number, TCP/IP address, domain name, or any other information that can be used to contact the sales system processor 110.

In an exemplary embodiment, the incentive offer is a sweepstakes contest or giveaway contest, whereby the entry number is the customer's participation number for the contest. In another exemplary embodiment, the entry number is the customer's phone number. In still another exemplary embodiment, the entry number is the customer's affinity program participation number. In yet another exemplary embodiment, the incentive offer is printed on a sales receipt.

In an exemplary embodiment, the entry number is provided to the POS system 134 and the POS system 140 by the sales system processor 110. The entry number provided by the sales system processor is associated with a particular customer. The POS system 134 will issue the particular customer the same entry number each time the particular customer purchases items from the POS system 134. Likewise, the POS system 140 will issue the particular customer the same entry number each time the particular customer purchases items from the POS system 140.

In an exemplary embodiment, the POS system 134 transmits the entry number, the UPCs of the scanned products, and any additional information known about the customer to the sales system processor 110.

In an exemplary embodiment, the POS system 134 generates the incentive offer associated with a particular campaign for the customer only if the customer purchases a certain type of product.

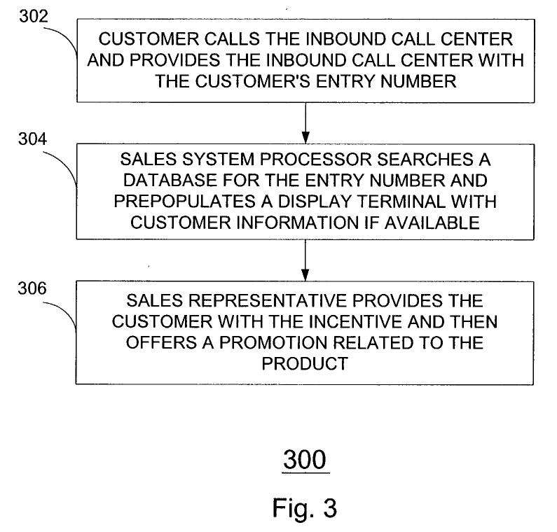

FIG. 3 is a flow chart that illustrates a series of steps 300 wherein the customer calls the sales system processor 110 in response to an incentive offer extended to the customer at a POS. The series of steps 300 begins at step 302 where a customer dials a phone number calling the sales system processor 110. Once the call is connected to the sales system processor 110 the customer will be asked to provide the entry number associated with the incentive offer received by the customer at the POS. An operator/sales representative answers the caller's call and asks the caller for the entry number, which the operator then inputs into the sales system processor 110.

In an exemplary embodiment, the phone number is a local toll free number. In another exemplary embodiment, the phone number is an “800”, “888” or other toll free telephone number.

In an exemplary embodiment, an interactive voice response unit (IVRU) answers the customer's call instead of the operator. The IVRU prompts the customer to key in the customer's entry number using the keypad on the customer's telephone. In another exemplary embodiment, the sales system processor 110 may utilize automatic number identification (ANI) information to search the customer database 120 for certain information relating to the customer and supply this information to the operator terminal display 118. In still another exemplary embodiment, the ANI information can be indicative of the caller's entry number. In yet another exemplary embodiment, the customer may interact with a web page, communicating via a keyboard, for example.

In an exemplary embodiment, the sales system processor 110 recognizes the called number utilizing dialed number identification service (DNIS). In response to receiving a particular called number via DNIS, the IVRU references the campaign database 124 and interacts with the customer in accordance with a script in accordance with a particular campaign that is specific to the called number, which was supplied to the customer at the POS.

At step 304 the sales system processor 110 searches the POS transaction database 122 and the partner database 126 for information relating to the entry number. If the POS transaction database 122 contains any information about the customer, that information is displayed to the operator terminal display 118. The information may include the customer's name and address.

In an exemplary embodiment, if an IVRU was used to respond to the customer initially, the IVRU causes the POS transaction database 122 to be searched for the entry number. If the entry number is found, the customer is transferred to an operator/sales representative and information relating to the customer is provided to the operator terminal display 118.

At step 306 the operator/sales representative provides the customer with the incentive from the incentive offer. By way of example, the providing of the benefit may include entering the customer/inquirer into a sweepstakes and/or agreeing to provide the customer/inquirer with a gift or prize. The operator may then engage the customer in a sales discussion. The operator is provided with information about the customer from the customer database 120, the POS transaction database 122, the partner database 126, and/or the UPC database 132 on the operator terminal display 118 and may offer to sell the customer a complimentary or competitive product or service to the product or service the customer has already purchased at the POS. For example, if the customer purchased a copy of Brand X magazine at the POS, the operator could offer to sell the customer a subscription to Brand X magazine or a subscription to Brand Y magazine. Once the operator has concluded the sales discussion with the customer, the operator terminates the call and the entry in the POS transaction database 122 corresponding to the entry number is updated to reflect the fact that the customer with that entry number just called the sales system processor 110.

In an exemplary embodiment, the sales system processor 110 provides the operator/sales representative with descriptions of products associated with the UPCs of the scanned products that the customer purchased at the POS system 134 when the incentive offer was extended to the customer, and the operator/sales representative uses these products to offer to sell the customer. In another exemplary embodiment, the operator/sales representative offers to sell the customer a particular product associated with the campaign about which the customer is calling.

The sales system processor 110 can be supported by a Rockwell Spectrum switch for an automated call distributor as provided by Rockwell Automation (300 Bauman Court, Wood Dale, Ill. 60191). Each inbound station can be equipped with CTI (Computer Telephony Integration), also provided by Rockwell, that allows voice and data to pass to subsequent call center representatives. The call center can be provided with real-time access to multiple management tools including call flow and sales activity that permit the efficient utilization of call-center representatives. Predictive workforce scheduling can also be used for forecasting inbound calls and to ensure sufficient numbers of representatives.

A transactional platform can be provided and integrated with the interface instructions for online credit verification at the sales system processor 110, as well as for managing recurring billing for multi-part orders and automatic renewal for continuous service. In addition, credits and chargebacks can be processed by the call center and customized billing descriptors for credit card statements can be generated. Billing options can be further enhanced by providing pay-by-check and invoicing capabilities.

One of ordinary skill in the art would be able to program variations to the routines in FIGS. 2 and 3 without deviating from the spirit and scope of the invention. The series of steps 200 and the series of steps 300 having the instructions for generating the computer-assisted portions of the method and system can be programmed using JavaScript, VBScript, Visual Basic, or the C programming language, among other programming languages. The series of steps 200 and the series of steps 300 can be incorporated into regular use with other graphical user interfaces or they can be provided as an independent unit such as by programming the interface as part of a dynamically-linked library. The databases, such as the customer database 120, the POS transaction database 122, the campaign database 124, the partner database 126, and the customer entry number database 128 can be provided separately or as an integrated database using commercially available database software such as is provided by Equifax (1550 Peachtree Street, N.W., P.O. Box 4081, Atlanta, Ga. 30309).

The invention has been described in connection with certain preferred embodiments. It will be appreciated that those skilled in the art can modify such embodiments without departing from the scope and spirit of the invention that is set forth in the appended claims. Accordingly, these descriptions are to be construed as illustrative only and are for the purpose of enabling those skilled in the art with the knowledge needed for carrying out the best mode of the invention. The exclusive use of all modifications and equivalents are reserved as covered by the present description and are understood to be within the scope of the appended claims.

We claim:

1. A method of receiving an inquiry in response to an offer extended to a customer at a point of sale, comprising the steps of:
receiving an inquiry in response to a document provided to a customer at a point of sale, the document having information including an offer for a benefit and telecommunication contact information for accepting the offer of the benefit, the inquiry being placed by an inquirer using the telecommunication contact information; and
offering at least one of an associated product and an associated service to the inquirer.

2. The method of receiving an inquiry in response to an offer extended to a customer at a point of sale, according to claim 1, wherein the document is a sales receipt.

3. The method of receiving an inquiry in response to an offer extended to a customer at a point of sale, according to claim 1, wherein the document is a ticket.

4. The method of receiving an inquiry in response to an offer extended to a customer at a point of sale, according to claim 1, wherein the document is a coupon.

5. The method of receiving an inquiry in response to an offer extended to a customer at a point of sale, according to claim 1, wherein the document is a sweepstakes entry.

6. The method of receiving an inquiry in response to an offer extended to a customer at a point of sale, according to claim 1, wherein the telecommunication contact information is a toll free telephone number.

7. The method of receiving an inquiry in response to an offer extended to a customer at a point of sale, according to claim 6, wherein the toll free telephone number is an eight-hundred number.

8. The method of receiving an inquiry in response to an offer extended to a customer at a point of sale, according to claim 1, wherein the document further includes an entry number.

9. The method of receiving an inquiry in response to an offer extended to a customer at a point of sale, according to claim 8, wherein the entry number is the inquirer's affinity program number.

10. The method of receiving an inquiry in response to an offer extended to a customer at a point of sale, according to claim 8, wherein the entry number is the inquirer's telephone number.

11. The method of receiving an inquiry in response to an offer extended to a customer at a point of sale, according to claim 8, wherein the receiving step further includes an interactive voice response unit answering the inquiry.

12. The method of receiving an inquiry in response to an offer extended to a customer at a point of sale, according to claim 11, wherein the interactive voice response unit prompts the inquirer to enter the entry number using a keypad on the inquirer's telephone.

13. The method of receiving an inquiry in response to an offer extended to a customer at a point of sale, according to claim 12, wherein the interactive voice response unit searches a database for information relating to the entry number.

14. The method of receiving an inquiry in response to an offer extended to a customer at a point of sale, according to claim 13 wherein the database includes the customer's name and address.

15. The method of receiving an inquiry in response to an offer extended to a customer at a point of sale, according to claim 12, wherein the receiving step further includes transferring the inquirer to an operator.

16. The method of receiving an inquiry in response to an offer extended to a customer at a point of sale, according to claim 1, wherein the customer is the inquirer.

17. The method of receiving an inquiry in response to an offer extended to a customer at a point of sale, according to claim 1, wherein the telecommunication contact information is indicative of an Internet address.

18. A method of generating at a point of sale a subsequent offer to a customer comprising the step of providing a document to the customer at a point of sale, the document having information including an offer for a benefit and telecommunication contact information for accepting the offer of the benefit by placing an inquiry in response to the document provided at the point of sale via the telecommunication contact information.

19. The method of generating at a point of sale a subsequent offer to a customer, according to claim 18, wherein the document further includes an entry number.

20. The method of generating at a point of sale a subsequent offer to a customer, according to claim 18, wherein the entry number is provided to the point of sale by an inbound call center.

21. The method of generating at a point of sale a subsequent offer to a customer, according to claim 18, wherein the telecommunication contact information is a toll free telephone number.

22. The method of generating at a point of sale a subsequent offer to a customer, according to claim 18, wherein the telecommunication contact information is indicative of an Internet address.

23. A method of generating at a point of sale a subsequent offer to an inquirer, comprising the steps of:
providing a document to a customer at a point of sale, the document having information including an offer for a benefit and telecommunication contact information for accepting the offer of the benefit;
receiving an inquiry via the telecommunication contact information from an inquirer; and
offering at least one of an associated product and an associated service to the inquirer.

24. The method of generating at a point of sale a subsequent offer to an inquirer, according to claim 23, wherein the document further includes an entry number.

25. The method of generating at a point of sale a subsequent offer to an inquirer, according to claim 24, wherein the entry number is provided to the point of sale by an inbound call center.

26. The method of generating at a point of sale a subsequent offer to an inquirer, according to claim 23, wherein the customer is the inquirer.

27. A method of receiving an inquiry in response to an offer extended to a customer at a point of sale, comprising the steps of:
receiving information about a customer including a customer entry number and information indicative of the customer's purchasing history, the information being obtained at least in part as part of an earlier point of sale transaction with the customer;
receiving an inquiry from an inquirer via telecommunication contact information provided to the customer at the point of sale, the inquiry including receiving from the inquirer the customer entry number;
providing the inquirer the benefit offered to the customer at the point of sale; and
offering at least one of a product and service to the inquirer based at least in part on the customer's purchasing history.

28. The method of receiving an inquiry in response to an offer extended to a customer at a point of sale, according to claim 27, wherein the customer is the inquirer.

29. The method of receiving an inquiry in response to an offer extended to a customer at a point of sale, according to claim 27, wherein the telecommunication contact information is indicative of an Internet address.

30. A system for receiving an inquiry in response to an offer extended to a customer at a point of sale, comprising:
an inquiry processing assembly configured to receive inquiries in response to a document provided at a point of sale, the document having information including an offer for a benefit and telecommunication contact information for accepting the offer of the benefit, the inquiry being placed by an inquirer using the telecommunication contact information, and configured to offer at least one of an associated product and an associated service to the inquirer.

31. The system for receiving an inquiry in response to an offer extended to a customer at a point of sale, according to claim 30, wherein the inquiry processing assembly is an interactive voice processing unit.

32. The system for receiving an inquiry in response to an offer extended to a customer at a point of sale, according to claim 30, wherein the inquiry processing assembly includes an operator station.

33. The system for receiving an inquiry in response to an offer extended to a customer at a point of sale, according to claim 32, wherein the operator station includes an audio interface and a video terminal.

34. A system for receiving an inquiry in response to an offer extended to a customer at a point of sale, comprising:
a processor configured to receive information about a customer including a customer entry number and information indicative of the customer's purchasing history, the information being received at least in part as part of an earlier point of sale transaction with the customer;
an interactive voice processing unit configured to receive an inquiry from an inquirer via telecommunication contact information provided to the customer at the point of sale, wherein the interactive voice response unit prompts the inquirer to enter the customer entry number, wherein the interactive voice response unit receives the customer entry number, and wherein the interactive voice response unit provides the inquirer the benefit offered to the customer at the point of sale; and
an operator terminal configured to display an offer of at least one of a product and a service to be communicated to the inquirer based at least in part on the customer's purchasing history.

35. The system for receiving an inquiry in response to an offer extended to a customer at a point of sale, according to claim 34, wherein the customer is the inquirer.

36. The system for receiving an inquiry in response to an offer extended to a customer at a point of sale, according to claim 34, wherein the telecommunication contact information is indicative of an Internet address.

37. A system for receiving an inquiry in response to an offer extended to a customer at a point of sale, comprising:
a processor configured to receive information about a customer including an offer for a benefit, a customer entry number and information indicative of the customer's purchasing history, the information being received at least in part as part of an earlier point of sale transaction with the customer; and
an operator terminal configured to receive an inquiry from an inquirer via telecommunication contact information provided to the customer at the point of sale, to display the benefit of the offer for a benefit, which is based at least in part on the customer entry number, and to display an offer of at least one of a product and a service to be communicated to the inquirer based at least in part on the customer's purchasing history.

38. The system for receiving an inquiry in response to an offer extended to a customer at a point of sale, according to claim 37, wherein the customer is the inquirer.

39. The system for receiving an inquiry in response to an offer extended to a customer at a point of sale, according to claim 37, wherein the telecommunication contact information is indicative of an Internet address.
